(19) United States
(12) Patent Application Publication
(10) Pub. No.: US 2010/0258672 A1
(43) Pub. Date: Oct. 14, 2010

(54) Aircraft, particularly an unmanned aircraft, having at least one weapons bay

(75) Inventors: Michael Grabmeier, Rosenheim (DE); Dieter Fasol, Taufkirchen (DE)

Correspondence Address: CROWELL & MORING LLP;INTELLECTUAL PROPERTY GROUP, P.O. BOX 14300, WASHINGTON, DC, 20044-4300, US

(73) Assignee: LFK-Lenkflugkoerpersysteme GmbH, Unterschleissheim (DE)

(21) Appl. No.: 11/502,453

(22) Filed: Aug. 11, 2006

(30) Foreign Application Priority Data
Aug. 13, 2005 (DE) 102005038382.3

(51) Int. Cl. B64C 7/00

(52) U.S. Cl. 244/118.2

(57) ABSTRACT

An aircraft, particularly an unmanned aircraft, has at least one weapons bay. At least one standardized equipment container can be inserted into the weapons bay.

### BACKGROUND AND SUMMARY OF THE INVENTION

This application claims the priority of German patent document 102005038382.3, filed Aug. 13, 2005, the disclosure of which is expressly incorporated by reference herein.

The present invention relates to an aircraft, particularly an unmanned aircraft, which has a weapons bay.

Conventionally, bomb pylons, on which guided or unguided bombs can be mounted, are provided in the weapons bay of aircraft. In addition, such aircraft are frequently equipped with other combat or defense devices, or with reconnaissance devices, in order to be able to carry out other tasks, as well. Particularly in the case of unmanned combat aircrafts (UCAVs), however, there is frequently no space for providing such additional devices. Moreover, military organizations are endeavoring to be able to use aircraft for an increasingly large number of tasks.

One object of the present invention, therefore, is to provide an aircraft of the above-mentioned type which can be utilized in a flexible manner for a large number of tasks without major expenditures and without major idle periods.

This and other objects and advantages are achieved by the aircraft and by the weapons bay arrangement according to the invention, in which at least one equipment container is provided which can be inserted into the weapons bay of the aircraft.

The invention thus provides the substantial advantage that such an equipment container can be inserted into the weapons bay of the aircraft at relatively low expenditures and within a relatively short time. Different equipment containers can be preconfigured and prefitted on the ground, so that the downtime of the aircraft on the ground between differing missions can be minimized because, aside from refueling of the aircraft, only the equipment container needs be exchanged.

The equipment container preferably has fastening devices by which it can be fastened to a bomb suspension provided in the weapons bay, This feature makes it possible to configure existing aircraft, which are conceived for dropping bombs, also with equipment containers, thereby integrating them into a flexible equipment container concept.

The equipment container is preferably equipped with releasable electric and/or optical connection units which cooperate with corresponding connection devices provided in the weapons bay, particularly on a bomb pylon. In addition to permitting mechanical mounting of the equipment container on the aircraft, this embodiment also permits the establishment of possibly existing and required electric and/or optical supply And communication connections between the aircraft and the equipment container or aircraft electronic devices contained therein.

In a preferred embodiment, the equipment container is an arms container, and preferably has at least one bomb receiving and bomb dropping device.

The equipment container can be equipped with communication devices for signal and/or data communication with a guidable bomb or another guided missile dropped from the equipment container. This permits the use also of intelligent weapons even if corresponding communication devices are not provided in the aircraft, because, according to this advantageous further development, such communication devices are contained in the equipment container itself, so that the aircraft is so equipped by the connection with the equipment container, only in the event of an actual requirement.

In another preferred embodiment, the equipment container is constructed as a dispenser for submunition.

The equipment container may preferably also have devices for the air reconnaissance. By means of such an equipment container, the aircraft can rapidly be retrofitted to serve as a reconnaissance aircraft.

The equipment container may also have receiving devices for tracking signals and/or devices for emitting interference and/or decoy signals. Thus, by using such a container, the aircraft can be retrofitted without difficulty to serve as an ECM (“Electronic Counter Measures”) aircraft. The corresponding equipment in the equipment container can then, for example, intercept radar radiation threatening the aircraft: the received radar signals are compared with known radar emitters by means of an existing library, and the pertaining weapons system is determined in a computer contained in the equipment container. The electronic system of the equipment container can then emit optimized interference and/or decoy signals for this determined weapons system. Thus, the effectiveness of the opponent's radar will be considerably limited with respect to target acquisition, target tracking and weapons usage. Free programmability of the computer unit contained in the thus equipped equipment container permits a constant adaptation to new threats.

The equipment container preferably has a rocket approach warning device and/or a dropping device for tracking interference devices. This equipment of the container is mainly used for providing defensive measures against infrared-controlled rockets. The equipment container configured in this manner thus forms an autonomous ICM (Infrared Counter Measures) system. Known tracking interference devices for interference with infrared-controlled rockets can be used as tracking interference devices.

The equipment container is preferably shaped such that, in the installed condition, it does not protrude beyond the outer contour of the aircraft so that the aerodynamic characteristics of the aircraft are not impaired. Preferably, the equipment container essentially completely fills the space of the weapons bay, so that the opening flaps of the weapons bay can be eliminated. The equipment container therefore forms an integral unit with the aircraft.

Also preferably, the equipment container or the weapons bay is equipped with at least one flap in the area of the skin of the aircraft, which flap can be opened and closed.

In a particularly preferred and advantageous embodiment of the invention, a plurality of differently equipped equipment containers are provided which have standardized mechanical fastening devices for fastening the equipment container on the aircraft, standardized electric and/or optical connection devices for connecting the equipment container with the aircraft and preferably a standardized outer shape. In this manner, the aircraft can be equipped with differently further developed equipment containers.

By means of such an equipment container concept, a flexible component assembly system is created which permits rapid fitting of the aircraft with different equipment containers, without major expenditures, depending on the mission which the aircraft is to carry out.

Other objects, advantages and novel features of the present invention will become apparent from the following detailed description of the invention when considered in conjunction with the accompanying drawings.

### BRIEF DESCRIPTION OF THE DRAWINGS

The single FIGURE is a schematic vertical sectional view of a lower fuselage section of an aircraft with an equipment container inserted into a weapons bay.

### DETAILED DESCRIPTION OF THE DRAWINGS

The FIGURE is a schematic vertical sectional view of a lower fuselage section of an aircraft 1 (not shown in detail) which has a weapons bay 10 on its underside. An equipment container 2 which is inserted into the weapons bay 10 of the aircraft 1 closes off essentially flush with the outer contour of the aircraft 1, so that it is not necessary to provide flaps for the weapons bay 10. The equipment container 2 is fastened to suspensions 12, 14 provided in the weapons bay 10. The equipment container 2 is electrically connected with a connection line 16 of the aircraft 1, (shown schematically), via a plug-type connection 20 (also not shown schematically), In the weapons bay 10, the connection line 16 has a corresponding plug-type connection 18 which is releasably connected with the plug-type connection 20. The equipment container 2 is supplied with electric power by the aircraft 1 via the connection line 16, and a data exchange between components of the equipment container 2 and the aircraft also takes place by way of the connection line 16.

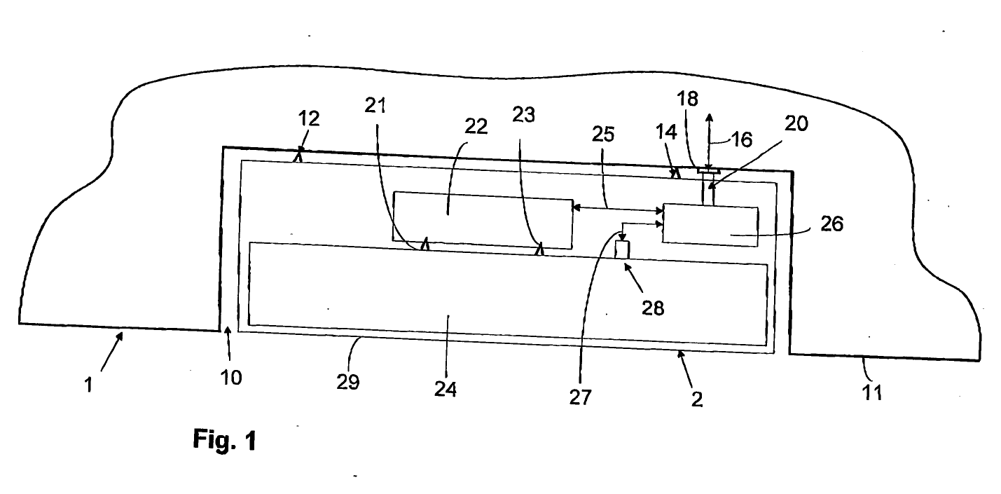

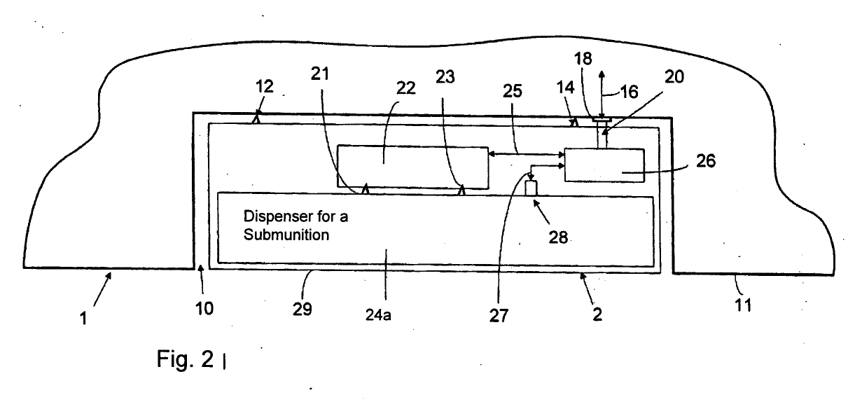

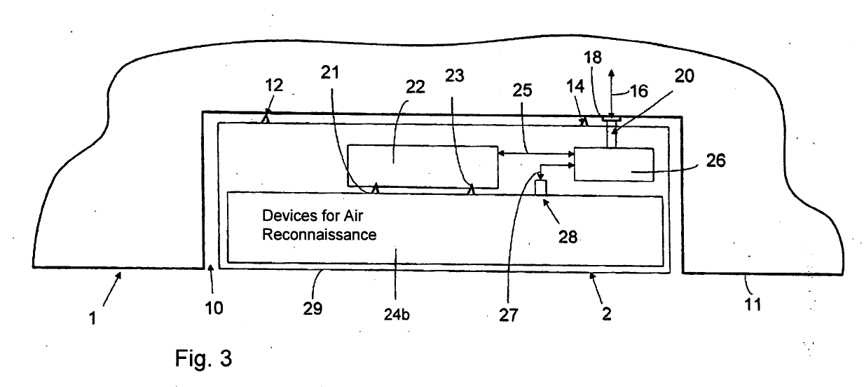

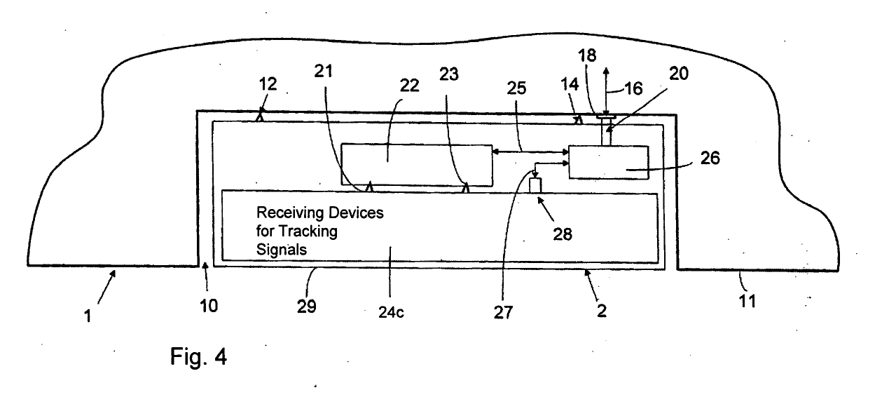

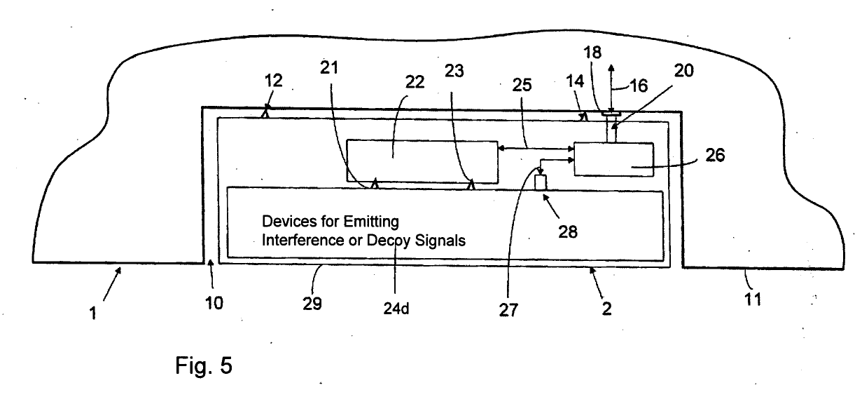

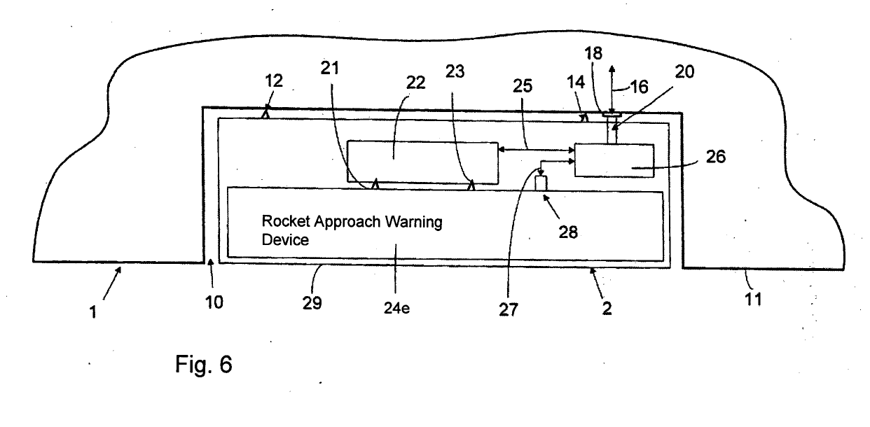

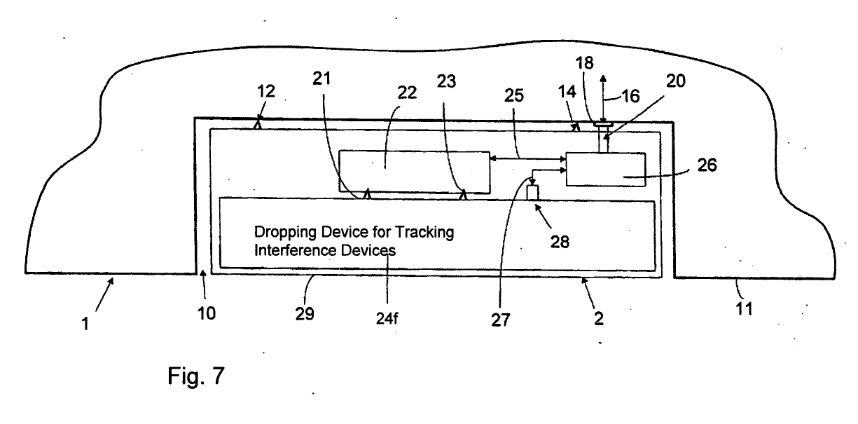

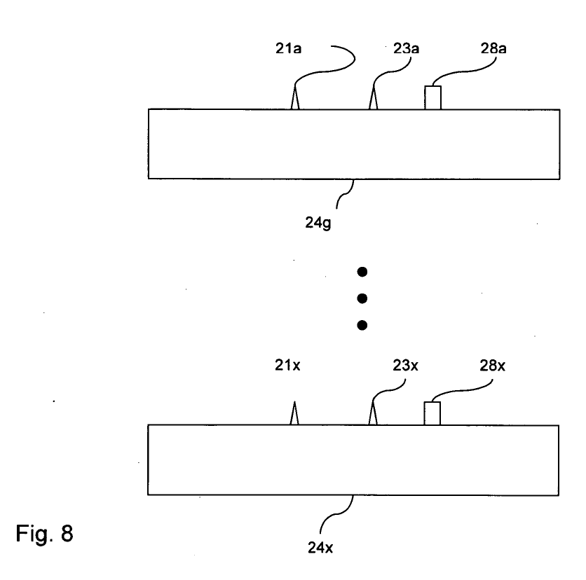

In FIG. 1, the equipment container 2 is illustrated, for example, as an arms container, in which case, a fastening and dropping device 22 ERU (ejection release unit) for a guidable bomb 24 is mounted on the top side of the equipment container 2 oriented toward the interior of the aircraft 1. The guidable bomb 24 is releasably mounted on the ERU 22 by means of holding devices 21, 23.

In addition, an interface unit 26 CIU (container interface unit) provided in the equipment container 2 is electrically connected via a line connection 25 with the ERU 22 and is releasably connected by way of a line connection 27 with a plug-type connection 28 provided at the guidable bomb 24.

On its underside, the equipment container 2 is provided with a flap 29 which is closed during the cruise and forms an essentially transitionless surface with the lower fuselage skin 11 of the aircraft 1. The flap 29 of the equipment container 2 can be opened if required in order to be able to, for example, drop a bomb 24. After the dropping of the bomb 24, the flap 29 is closed again. (Instead of one flap 29, of course, several flaps may be provided.)

The equipment container exists in several equipment variants, the outer shape and the interface hardware always being developed identically with respect to the aircraft. Depending on the mission to be flown, the suitable equipment variant of the equipment container 2 is then inserted into the weapons bay 10 of the aircraft 1 and is mechanically and electrically connected there with the aircraft.

In another equipment variant (not shown), the equipment container 2 may be equipped with a swivelably controllable video camera which operates in the visible wavelength range or in the infrared wavelength range. In this case, a laser designator is also provided in the equipment container for the target selection and target illumination, by means of which laser designator laser-guided bombs also present in the equipment container 2 can be guided to the target by an operator in the aircraft or in a remote control station. The transmission of the control data for the laser-guided bomb as well as of the video data takes place analogously to the data transmission described in connection with FIG. 1 by way of the plug-type connection 18, 20 and the connection line 16 into the aircraft and, as required, from the aircraft by way of a radio link to the remote control station. This equipment variant permits the engagement of small movable targets by means of the video camera, as well as a result check by means of the video camera.

Reference numbers in the claims, the specification and the drawings are used only for a better understanding of the invention and do not have the purpose of limiting the scope of the protection.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE NUMBERS

1 Aircraft

2 equipment container

10 weapons bay

11 lower fuselage skin

12 suspension

14 suspension

16 connection line

18 plug-type connection

20 plug-type connection

21 holding device

22 ERU

23 holding device

24 guidable bomb

25 line connection

26 CIU

27 line connection

28 plug-type connection

29 flap

1-20. (canceled)

21. A flexible component assembly system for fitting of an aircraft with an equipment container in an aircraft weapons bay, the system being provided with a plurality of differently equipped containers which have standardized mechanical fastening devices for fastening the equipment container on the aircraft, standardized electric or optical connection devices for connecting the equipment container with the aircraft, and a standardized outer shape,
wherein the equipment container includes at least one of the differently equipped containers, including a bomb dropping device, a communication device, a dispenser for submunition, a device for air reconnaissance, a receiving device for tracking signals, a device for emitting interference signals, a device for emitting decoy signals, a rocket approach warning device, and a dropping device for tracking interference devices,
wherein, regardless of which of the plurality of the differently equipped containers is provided in the system, the equipment container has same mechanical fastening devices, same electric or optical connection devices and a same outer shape, and
wherein, when a connection is established between the aircraft and the equipment container, the connection provides at least one of feeding electric power from the aircraft to the equipment container and enabling electric or optical signals to travel between the aircraft and the equipment container.

22-23. (canceled)

24. An aircraft having a flapless weapons bay arrangement in which at least one equipment container having at least one flap is insertable into the weapons bay, wherein the equipment container, when inserted in the weapons bay, essentially completely fills the space of the weapons bay or is flush with an outer contour of the aircraft,
wherein the equipment container includes at least one of a plurality of different types of equipment, including a bomb dropping device, a communication device, a dispenser for submunition, a device for air reconnaissance, a receiving device for tracking signals, a device for emitting interference signals, a device for emitting decoy signals, a rocket approach warning device, and a dropping device for tracking interference devices, and
wherein, regardless of which of the plurality of the different types of equipment is included in the equipment container, the equipment container has same mechanical fastening devices, same electric or optical connection devices, a same outer shape, and essentially completely fills the space of the weapons bay by a same amount.

25. A method of mounting different types of equipment in a weapons bay of an aircraft depending on a mission which the aircraft is to carry out, the weapons bay being provided with a suspension, the method comprising:
preconfiguring an equipment container with at least one of the different types of equipment, including a bomb dropping device, a communication device, a dispenser for submunition, a device for air reconnaissance, a receiving device for tracking signals, a device for emitting interference signals, a device for emitting decoy signals, a rocket approach warning device, and a dropping device for tracking interference devices;
inserting the equipment container into the weapons bay; and
fastening the equipment container to the suspension in the weapons bay;
wherein the equipment container includes standardized mechanical fastening devices for fastening the equipment container to the suspension, standardized electric or optical connection devices for connecting the equipment container with the aircraft, and a standardized outer shape, such that, regardless of which of the bomb dropping device, the communication device, the dispenser for submunition, the device for air reconnaissance, the receiving device for tracking signals, the device for emitting interference signals, the device for emitting decoy signals, the rocket approach warning device, and the dropping device for tracking interference devices is mounted in the weapons bay, the equipment container has same mechanical fastening devices, same electric or optical connection devices and a same outer shape.

26-28. (canceled)
